(19) United States
(12) Patent Application Publication
(10) Pub. No.: US 2008/0061474 A1
(43) Pub. Date: Mar. 13, 2008

(54) Thermally stabilized adhesion promoting material for use in multilayer articles

(75) Inventors: Philip D. Bourgeois, Red Lion, PA (US); Sharad Shah, York, PA (US)

Correspondence Address: RISSMAN JOBSE HENDRICKS & OLIVERIO, LLP, 100 Cambridge Street, Suite 2101, BOSTON, MA, 02114, US

(73) Assignee: Graham Packaging Company, LP, York, PA (US)

(21) Appl. No.: 11/518,668

(22) Filed: Sep. 11, 2006

(51) Int. Cl. B29C 39/00

(52) U.S. Cl. 264/299; 428/35.7

(57) ABSTRACT

A thermally stabilized adhesion promoting amine polymer is used in melt forming a multilayer article having adjacent layers of matrix and barrier resins. A phosphorous material is used to reduce or eliminate coloring or other thermal degradation of the adhesion promoting amine polymer.

### FIELD OF THE INVENTION

The present invention relates to an adhesion promoting material for use in multilayer articles, and more specifically to a thermally stabilized amine polymer material that promotes adhesion between adjacent barrier resin and matrix resin layers in a melt-formed multilayer article.

### BACKGROUND OF THE INVENTION

Injection and extrusion molding are well known methods for manufacturing plastic articles known as preforms which may subsequently be expanded (e.g., blow molded) into bottles or other containers. In particular, it is desirable to produce clear and transparent articles from such materials.

When plastic materials are subjected to elevated temperatures and pressures as are typically used in the referenced molding processes, the plastic materials can be prone to molecular degradation, unwanted polymerization and unwanted reaction with other materials that may be present in the plastic material. Such polymer reaction processes can cause the plastic material to acquire undesirable coloring, yellowing, blackening, haze or other degradation of transparency.

Poly(ethylene vinyl alcohol) copolymer (EVOH) is a well known thermoplastic barrier resin having a low gas transmission rate and which resists transmission of flavorants, including odorants and essential oils. It is widely used in multilayer plastic containers and preforms which typically include one or more layers of a plastic matrix resin, such as polyethylene terephthalate (PET), alternating with one or more adjacent layers of the EVOH barrier resin. Polyamide, such as MXD6 polyamide, is another well known thermoplastic barrier resin used in multilayer plastic containers and preforms in the food and beverage industry.

An important property of such multilayer containers is the ability to resist delamination between the various layers during filling and handling by the container manufacturer and the product packager, and during use of the container by the consumer. It is desired to provide such adhesion without detrimentally affecting the container's other features, such as the barrier properties and container transparency and clarity.

An alkylene amine polymer has been added to one or both of a barrier resin layer and an adjacent matrix resin layer to promote bonding between the layers. See U.S. 2005/00845635A1 published Apr. 21, 2005, Delamination-Resistant Multilayer Container, Preform, Article and Method of Manufacture, by Philip D. Bourgeois, which describes use of such adhesion promoting amine polymers, and preferably alkylene amine polymers such as polyethyleneimine (PEI). However, it has been found that such adhesion promoting amine polymers, if subjected to long process residence times, can thermally degrade during melt processing of the type used to form a multilayer article, e.g., injection or extrusion molding. Such thermal degradation may cause a yellowing, blackening, or other degradation in properties such that the multilayer wall is no longer clear and transparent. Providing clear and transparent packaging articles is particularly important in the food and beverage industry where, for example, PET is in dominant use as a matrix layer material due to its superior transparency and high gloss, and thin adjacent layers of EVOH and/or polyamide are used to provide enhanced gas barrier protection without substantial loss of clarity or transparency of the overall multilayer container wall.

### SUMMARY OF THE INVENTION

In accordance with various embodiments of the invention, there are provided phosphorous containing polymer materials, articles formed thereof, and methods of forming such articles. It has been found that the addition of phosphorous facilitates the melt processing of an amine polymer material used to promote adhesion between adjacent barrier resin and matrix resin layers of a melt formed multilayer article. The adhesion promoting material includes an amine polymer and an amount of phosphorous material sufficient to thermally stabilize (e.g., reduce or eliminate a color change such as yellowing of) the material, in melt forming of the article. The matrix resin is preferably an ester containing polymer such as polyester, and more preferably polyethylene terephthalate (PET). The barrier resin is preferably EVOH or polyamide. The amine polymer is preferably an alkylene amine polymer, such as polyethyleneimine (PEI). The phosphorous material preferably comprises a phosphorus atom bound to one or more oxygen atoms, the one or more oxygen atoms being bound to an organic substituent that includes an aromatic moiety. Preferred as a phosphorous material are a phosphite, phosphonite and a phosphate, and more preferably a phosphite.

In one embodiment, a melt formed multilayer article is provided which includes:
at least one layer of matrix resin;
at least one layer of barrier resin; and
a material blended with the barrier resin and/or matrix resin to promote adhesion between the barrier and matrix layers, the adhesion promoting material including an amine polymer and an amount of a phosphorous material sufficient to thermally stabilize the adhesion promoting material in melt forming of the article.

The phosphorous material may be present in an amount sufficient to reduce or eliminate color changes of the adhesion promoting material during melt forming, and more preferably to reduce or eliminate yellowing of the adhesion promoting material.

In various embodiments, the amine polymer is an alkylene amine polymer, such as an alkylene imine polymer, and more particularly polyethyleneimine polymer.

The phosphorous material may comprise a phosphorous atom bound to one or more oxygen atoms. The one or more oxygen atoms may be bound to an organic substitutent, the organic substituent including an aromatic moiety. The phosphorous material may include two or more aromatic moieties bound to the phosphorous atom. The phosphorous material may comprise one or more of a phosphite, a phosphonite, and a phosphate. The phosphorous material is preferably a phosphite, which preferably includes one or more oxygen atoms bound to an organic substituent, wherein the organic substituent includes an aromatic moiety.

In various embodiments, the matrix resin is an ester containing resin, polyolefin or polyamide. Preferably the matrix resin is polyester resin, and more specifically the polyester resin is PET, PEN, a blend or copolymer of PET and PEN or regrind that includes PET, PEN or blends or copolymers of PET and PEN.

The barrier resin may be EVOH, polyamide, acrylonitrile copolymer, a blend of EVOH and polyamide, a blend of polyester and polyamide, a nanocomposite of EVOH or polyamide and clay, a blend of EVOH and ionomer, acrylonitrile, a cyclic olefin copolymer, polyglycolic acid, polyvinylidiene chloride, or a blend thereof. More preferably, the barrier resin is EVOH or polyamide, such as MXD6 polyamide.

The article may be a food or beverage preform or container. Alternatively, the article is a preform or container for organic liquids or solvents. The article may be a package, container, preform, closure, liner, sheath or film. Preferably, the adhesion promoting material in the article is substantially clear and transparent.

In various embodiments, the elemental phosphorous content of the adhesion promoting material is preferably in a range of from about 0.1% to about 1.0% by weight of the amine polymer. More preferably, the elemental phosphorous content is in a range of 0.5% to 1.0%.

In another embodiment, a method is provided of melt forming a multilayer plastic article that includes the steps of:
(a) blending with a barrier resin an adhesion promoting material comprising an amine polymer and an amount of phosphorous material sufficient to thermally stabilize the adhesion promoting material in melt forming of the article; and
(b) melt forming the article in which the blend formed in step (a) is in a layer adjacent to a layer of matrix resin, and in which the amine polymer promotes adhesion between the barrier and matrix layers.

In another embodiment, a barrier resin blend is provided for use in melt forming a multilayer plastic article. The barrier resin blend includes:
a barrier resin to resist transmission of one or more of gas, water vapor and flavorants, and
a material that includes an amine polymer to promote adhesion between the layer of the barrier resin and an adjacent layer of a matrix resin in the melt formed article, the adhesion promoting material including an amount of a phosphorous material sufficient to thermally stabilize the adhesion promoting material in melt forming of the article.

These and other advantages of several embodiments of the invention may be better understood by referring to the following detailed description in conjunction with the accompanying drawings.

### BRIEF DESCRIPTION OF THE DRAWINGS

FIG. 1A is a schematic view of a multilayer preform which includes adjacent layers of polymer materials according to one embodiment of the present invention, and FIG. 1B is an expanded partial cross-sectional view of a multilayer sidewall of the preform;

FIG. 2A is a schematic view of a blow molded container made from the preform of FIG. 1A, and FIG. 2B is an enlarged partial cross-sectional view of a multilayer sidewall of the container;

FIGS. 3A-3D are a series of sequential illustrations of a method for injection molding which may be used to make melt-formed multilayer articles according to various embodiments of the invention.

### DETAILED DESCRIPTION

It has been found that a phosphorous material can be used to reduce or eliminate coloring or other thermal degradation of an adhesion promoting material containing an amine polymer. This thermally stabilized amine polymer can then be used in forming a multilayer article (all or a portion thereof) which article is formed by melt processing (e.g., melt forming by injection, extrusion, compression or over-molding wherein at least one polymer material is in melt phase during forming of a multilayer structure). Various aspects of the invention, as described in the embodiments below, may be used independently and/or in various combinations to provide compositions, methods and articles in accordance with the invention.

Transparent as used herein refers to a polymer material that is substantially transparent such that the amount of haze (opacity) is not significantly detectable by unaided human vision. A suitable measure of transparency is the percent haze for transmitted light through the wall (H_{T}) which is given by the formula:

H_{T}=[Y_{d}÷(Y_{d}+Yₛ)]×100

where Y_{d} is the diffuse light transmitted by the specimen, and Yₛ is the specular light transmitted by the specimen. The diffuse and specular light transmission values are measured in accordance with ASTM Method D 1003, using any standard color difference meter such as the UltraScan XE manufactured by HunterLab Inc. (www.HunterLab.com). Preferably, a substantially transparent article, such as a beverage container, would have a percent haze through the sidewall of less than about 15%, and more preferably less than about 10%.

Clear as used herein refers to a polymer material that is substantially lacking in color (e.g., yellow) such that the amount of color is not sufficiently detectable by unaided human vision. Preferably, the phosphorous material is added to the processed polymer materials in an amount sufficient to reduce the standard HunterLab yellow “b value” of the material to less than about 5 as measured in a plaque having a thickness of between about 0.5 and about 3.0 mm. A convention for measurement of such “b values” is described in HunterLab application Note, Insight on Color, Vol. 8, No. 9, pp. 1-4 (Aug. 1-15, 1996), (available at www.HunterLab.com).

Polymer material as used herein means a homopolymer but also copolymers thereof, including random copolymers, block copolymers, graft copolymers, etc. A polymer material may be of a single polymer or a mixture or blend of multiple polymers; it may further include relatively smaller amounts of nonpolymer materials added for any of various processing or performance characteristics.

A “barrier material” as used herein is any material that exhibits a reduced rate of permeation for a particular substance, such as a gas, water vapor or flavorants, in comparison to another material. A “passive barrier material” is generally understood to reduce the rate of permeation by blocking passage of the particular substance, e.g., oxygen or carbon dioxide. An “active barrier material” is commonly understood to refer to a material having the ability to consume a particular substance through chemical and/or physical means. In the context of a closed environment with the active barrier material present, the consumption of for example molecular oxygen may eliminate or substantially reduce the net ingress of oxygen into the closed environment. Moreover, the consumption of molecular oxygen may reduce the total enclosed amount of molecular oxygen.

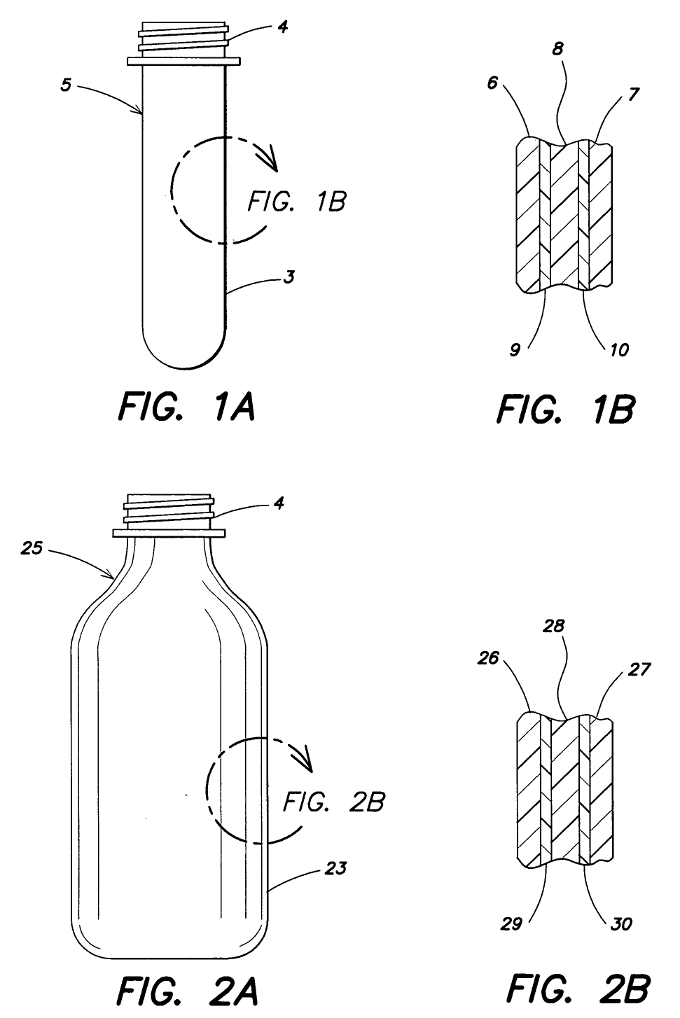

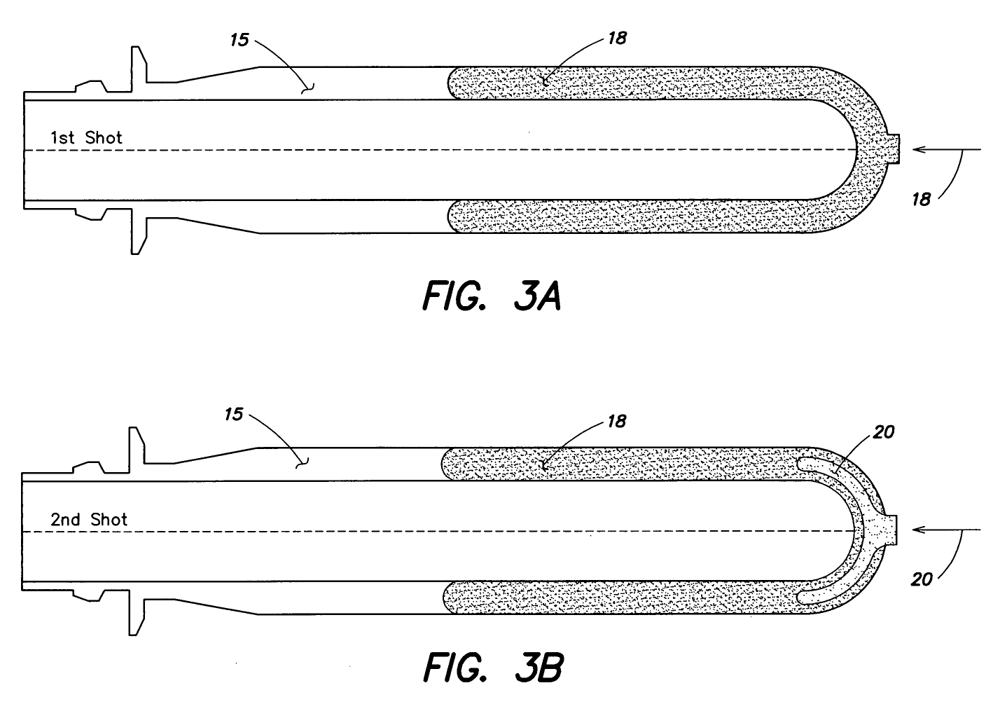

FIG. 1A shows a multilayer preform 5 having a neck finish 4 and a five-layer sidewall 3, the sidewall including exterior inner and outer layers 6 and 7, central core layer 8, and interior intermediate layers 9 and 10 (see the expanded view of FIG. 1B). FIG. 2A shows a container 25 blown from the preform 5 having the same unexpanded neck finish 4 and an expanded five-layer sidewall 23 with corresponding layers 26-30 (see the expanded view of FIG. 2B). The phosphorous containing adhesion promoting material is provided in one or more adjacent barrier resin and matrix resin layers. The phosphorous containing layer may or may not make physical contact with the product (e.g., food or drink) that is ultimately packaged or enclosed within the interior space of the bottle. In one example, the preform and container each have a five-layer wall 3, 23 comprising PET/EVOH/PET/EVOH/PET (as layers 6/9/8/10/7 and 26/29/28/30/27 respectively). In another example the five layer wall comprises PET/MXD6/PET/MXD6/PET.

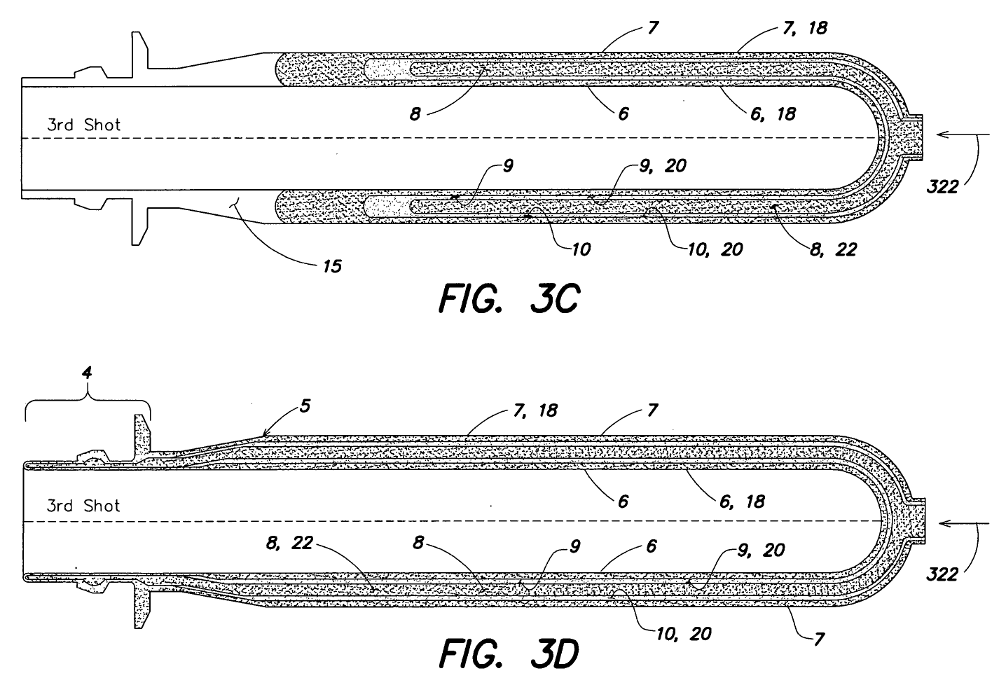

An exemplary multilayer injection molding process, which may be used to form the five-layer preform of FIG. 1A, is shown schematically in FIGS. 3A-3D. A preform is formed in a mold cavity 15 between an outer mold and inner core (not shown) of a conventional injection mold. A first shot of first polymer material 18 (e.g., matrix resin) is injected into the lower end (gate) of the mold cavity and as it flows through the mold cavity, due to the relatively cool temperatures of the outer mold and inner core, there will be solidification of the first polymer material on the core and outer mold walls to define exterior inner and outer layers (layers 6 and 7 in FIG. 1B) of the first material. In FIG. 3A, the relatively large volume of first material has progressed part way (roughly half way) up the mold cavity walls. As shown in FIG. 3B, a second shot of a second polymer material (e.g., a barrier resin) is injected into the bottom of the mold cavity. The relatively small amount of barrier material 20 may pool at the lower end of the cavity. A relatively large third shot of a third polymer material 22 (e.g., matrix resin) is then injected into the gate at a pressure which causes the second shot material 20 to be pushed up the mold cavity and form inner and outer intermediate layers (9, 10 in FIG. 1B) of the preform, while the third material 22 forms a central core layer (layer 8 in FIG. 1B). The tunnel flow of the second and third shots, between the exterior layers 6 and 7, enables the formation of relatively uniform and thin intermediate layers 9 and 10 of the barrier resin 20, and a thicker layer of matrix resin 22 in the core layer 8. Finally, the advancing layers reach the terminal end of the mold cavity, producing the five-layer preform structure having interior intermediate and core layers extending up into the neck finish (as shown in FIG. 3D). Alternatively, the interior layers 8, 9 and 10 may extend only partially up the preform wall and terminate, for example, below the preform neck finish 4.

This process is described by way of example only, and it not meant to be limiting; many other processes may be used to form multilayer articles, including articles other than preforms. Typical examples of multilayered preforms, bottles and packages, the compositions of the various layers of such multilayer objects, and methods of making such objects are disclosed in U.S. Pat. Nos. 4,781,954; 4,863,046; 5,599,496; and 6,090,460, disclosures of all of the foregoing of which are incorporated herein by reference.

### Phosphorous Material

One or more phosphorous containing materials having the following formula can be used as an additive to the amine polymer material according to various embodiments of the invention: P—(O—R)₃ or R₁—P—(O—R)₂ or P—(O—R)₄ or R₁—P—(O—R)₃ or (R₁)₂—P—(O—R)₂, where R and R₁ are H or an organic substituent, most preferably containing an aromatic moiety. Specific examples of suitable phosphorous containing compounds are:

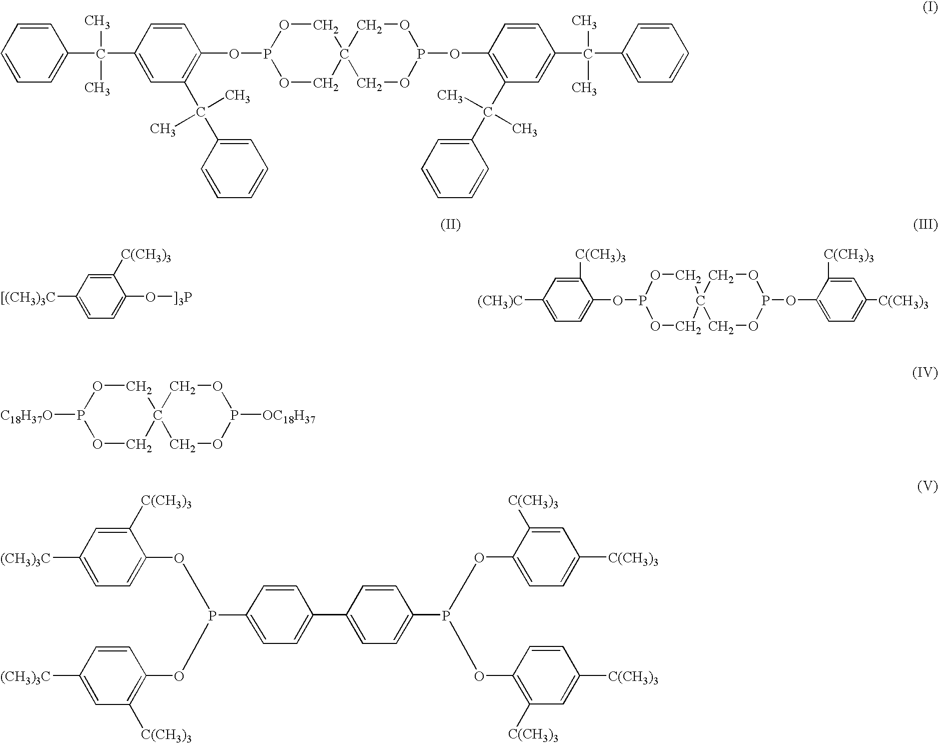

In select embodiments, the phosphorous is added an amount sufficient to reduce or eliminate discoloration. However, in other embodiments the phosphorous is added in an amount sufficient to reduce or eliminate the formation of haze, to reduce or eliminate a loss of melt viscosity (or other indicator of melt processability), or otherwise thermally stabilize (reduce or avoid one or more of the problems identified in paragraph 3 herein) the melt formed and cooled polymer material.

Preferred phosphorous containing materials are those having a phosphorous atom bound to one or more oxygen atoms, one or more of which are in turn bound to an organic substituent, most preferably an organic substituent that contains one or more aromatic moieties. The phosphorous atom is most preferably bound to two or more aromatic moieties either through an oxygen atom or directly. The phosphorous containing material is preferably a phosphite, phosphonite or phosphate, most preferably a phosphite.

The following phosphorous containing compounds are suitable examples:

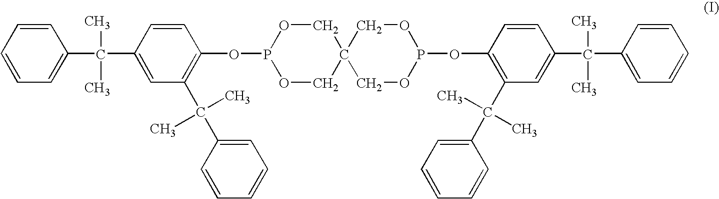

bis(2,4-dicumylphenyl)pentaerythritol diphosphite, CAS Registry No. 15486243-8, available as Doverphos S-9228 (7.3 weight percent phosphorous) from Dover Chemical Corporation, 3676 Davis Road, N.W., P.O. Box 40, Dover, Ohio 44622-0040, USA;

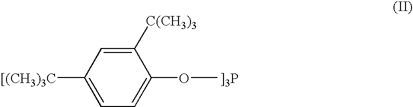

tris(2,4-di-t-butylphenyl)phosphite, available as Doverphos S-480 from Dover Chemical Corp., or as Irgafos 168 (4.8 weight percent phosphorous) from Ciba Specialty Chemicals, Basel, CH;

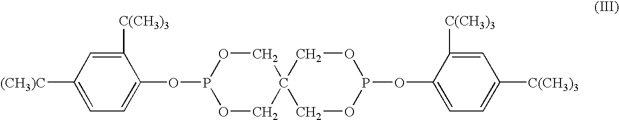

bis(2,4-di-t-butylphenyl)pentaerythritol diphosphite available as Doverphos S-9432 from Dover Chemical Corp.;

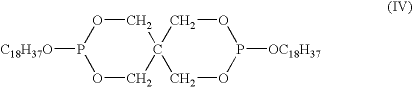

distearyl pentaerythritol diphosphite available as Doverphos S-682 from Dover Chemical Corp.; and

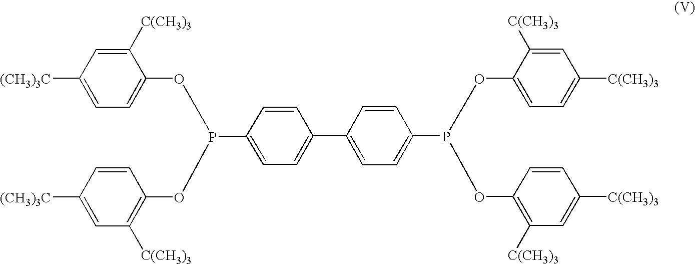

tetrakis(2,4-di-t-butylphenyl)4,4′-biphenylene diphosphonite available as P-4 from Dover Chemical Corp.

The phosphorous material, when added to the amine polymer material, may (without being bound or limited to this theory) interfere with or reduce degradation of the amine polymer material and/or other materials that are present in a melt mixture of the amine polymer and other polymers (e.g., barrier resin and/or matrix resin). Thus the phosphorous material can prevent or lessen: a darkening, yellowing or other color formation; a reduction in viscosity; and/or a formation of haze in the body of the polymer materials when subjected to melt forming (e.g., extrusion or injection molding) process.

Phosphorous is typically added to the amine polymer material as a phosphorous containing additive, before and/or during the melt forming step. In all embodiments described herein, the amount of elemental phosphorous provided in the melt is based on the weight percentage of the amine polymer.

When phosphorous is provided as part of a phosphorous containing additive, the mathematical relationship of the weight percentage elemental phosphorous to the weight of additive can be determined as follows, where the weight of amine polymer is the amount in the melt:

$$\% elemental phosphorous = \frac{{ω}_{additive}}{{ω}_{additive} + {ω}_{aminepolymer}} \times \% {P}_{additive}$$

ω=weight of additive

ω_{aminepolymer}=weight of amine polymer

% P_{additive}=% elemental phosphorous content of the additive.

Preferably, the phosphorous containing material is added to the amine polymer in an amount such that the elemental phosphorous content of the mixture is in a range of from about 0.01% to about 1.0% by weight of the additive/amine polymer mixture, and more preferably in a range of from 0.5% to 1.0%. Providing more than the minimum amount of phosphorous required to achieve a desired functional (thermal stabilizing) effect is contemplated as being within the scope of the present invention.

### Adhesion Promoting Amine Polymer Material

A melt-formed multilayer article in accordance with one embodiment of the invention includes a multilayer wall having at least one layer of matrix resin, at least one layer of barrier resin, and an adhesion promoting material blended with the barrier resin and/or the matrix resin to promote bonding between the barrier and matrix layers. In one preferred embodiment, the adhesion promoting material is blended with the barrier resin. The adhesion promoting material is an amine polymer having a plurality of available primary, secondary, or tertiary amine groups. The polyamine polymer is preferably an alkylene amine polymer. Alkylene imine polymers, such as polyethylenimine (PEI) polymers, are particularly preferred. PEI polymers are marketed under the trade name EPOMIN by Nippon Shokubai Co., Ltd. For example, EPOMIN Grade SP-012 PEI material has the following properties (according to the resin manufacturer):

| Molecular weight | 1200 (approx.) |
|---|---|
| Specific gravity | 1.05 @ 25° C. |
| Amine value | 19 mg eq./g solid |
| Freezing point | Less than −20° C. |
| Decomposition temp. | 290° C. |
| Flash point | 260° C. |
| Amine ratios | |
| primary | 35% |
| secondary | 35% |
| tertiary | 30% |
| Chemical Abstract Specification (CAS) No. | 106899-94-9 |

The grade SP-012 material is stated by the manufacturer to be soluble in water and alcohol, partially soluble in ethylacetate, THF and toluene, and insoluble in n-hexane. Other PEI polymers may be employed, including other EPOMIN polymers, and PEI polymers marketed by BASF Aktiengesellschaft, Ludwigshafen, Germany, under the trade name LUPASOL.

The polyamines of the adhesion promoting material are polymeric, either homopolymeric or copolymeric polyamines, and may comprise an alkylene amine polymer or an alkylene imine polymer having a molecular weight of from about 150 to about 2,000,000, with about 150 to about 400,000 preferred, and most preferred being from about 300 to about 80,000. Examples of polyamines include polyvinyl amines, aminofunctional polyacrylamides, polyDADMAC's, polyvinyl pyrrolidone copolymers, polyethyleneimine, polypropyleneimine and the reaction product of ethylene diamine and epichlorohydrin copolymers.

A preferred polyamine that can be used to achieve adhesion promoting characteristics is the class of polyamines referred to as polyalkyleneimines, such as polyethyleneimine, which is readily available in a wide range of molecular weights and different degrees of branchings. Polyethyleneimines consist of a large family of water-soluble polyamines of varying molecular weight and degree of chemical modification. It is generally known that the polymerization of ethyleneimine does not result in a polymer that is completely composed of units having a linear structure, but that also the degree of branching in polyethyleneimines depends on the acid concentration and the temperature during polymerization. Additional groups may be grafted onto polyethyleneimines using methods well known in the art to change other desirable physical and chemical properties. Preferred molecular weights of the polyethyleneimine are from about 150 to 80,000. More preferred molecular weights of the polyethyleneimine are from about 300 to 80,000 for reasons of material viscosity.

As an additional feature of the PEI polymers blended in the barrier or matrix layer is that they can also interact with acidic gases such as carbon dioxide to provide enhanced acidic gas barrier polymers, e.g., to increase carbon dioxide barrier performance of the container. This is particularly useful in reducing carbon dioxide loss from the package when the container is used to package carbonated beverages such as soft drinks or beer.

The matrix polymer preferably is an ester containing polymer, i.e., polymers having an ester in the main polymer chain, ester moieties grafted to the main polymer chain, or ester moieties as side groups to the chain. The ester is preferably in the main polymer chain, and polyesters are particularly preferred. Terephthalate-based polyesters are most preferred; such resins generally have at least 70 mol % of the ester repeating units occupied by terephthalate units and it is preferable that the glass transition point (T_{g}) be in a range from 50 to 90° C. and the melting point be in a range from 200 to 275° C. Polyethylene terephthalate (PET) exhibits particularly excellent thermal and pressure resistance in thin-walled containers, as well as clarity and transparency. The PET may be homopolymer, copolymer or blend, including, for example, a small quantity of ester units formed of dibasic acid such as isophthalic acid, naphthalene dicarboxylic acid or the like, and diol such as propylene glycol or the like, besides the ethylene terephthalate units. Thus as used herein, PET includes such copolymers and blends which are substantially PET.

Other suitable polyesters include polybutylene terephthalate (PBT), polypropylene terephthalate (PPT), polyethylene naphthalate (PEN), polyglycolic acid (PGA), polycarbonate (PC) and polylactic acid (PLA). Also usable are blends and copolymers of the above, and recycled material (e.g., process scrap and/or post-consumer regrind) that consists essentially of such polymers.

The PEI polymers are known to carry a high cationic charge density by virtue of their incorporation of high amounts of primary, secondary and tertiary amine functionalities. While not being bound to any particular theory, it appears that these amine functionalities strongly interact with esters or other functional groups to achieve improved adhesion between the barrier and matrix containing layers to reduce or prevent delamination of the wall layers during handling and use of the containers.

It is currently preferred that the adhesion promoting amine polymer material be blended with the barrier resin. Because the barrier resin layers generally form a relatively small percentage by weight of the overall preform or container, a lesser quantity of adhesion promoting material is required than if the adhesion promoting material is blended with the matrix resin. However, the adhesion promoting material could be blended with the matrix resin, or with both the matrix resin and the barrier resin, in accordance with the broader aspects of the invention.

The adhesion promoting amine polymer material typically is in the form of a liquid, and preferably is blended with the EVOH barrier resin material prior to forming the multilayer preform or container. This blending may be performed by high pressure liquid injection of the adhesion promoting material into an extruder through which the barrier material is flowing, or by placing the barrier material into the same feed throat of the extruder in such a way that the adhesion promoting material and the barrier resin do not come into contact until they are adjacent to the extruder screw. Alternatively, the high pressure liquid injection resin method or common feedthroat method described above for the introduction of the adhesion promoting material to the EVOH barrier resin may be employed to make an adhesion promoting material-EVOH master batch material that is subsequently pelletized by methods well known in the art. These masterbatch pellets can then be blended with the EVOH barrier resin at an appropriate dilution ratio prior to forming the multilayer preform or container. It is preferred to first add the phosphorous material to the amine polymer, before combining it with the EVOH barrier resin.

The amount of adhesion promoting resin usually is no more than is necessary to achieve the desired level of adhesion, as increasing the proportion of adhesion promoting material may affect the viscosity or other properties of the resin with which it is blended. The amount of adhesion promoting material blended with the barrier resin or the matrix resin preferably does not exceed about 10%, and preferably does not exceed 5% by weight of the blend used to form the multilayer article. In this regard, the adhesion promoting material preferably is blended with the barrier resin and preferably does not exceed about 10% by weight of the blend. The amount of adhesion promoting material more preferably does not exceed about 5% by weight of the blend with the barrier resin used to form the multilayer articles. In many applications, the amount of the adhesion promoting material does not exceed 2% or 3% by weight of the blend with the barrier resin. All blend percentages in this application are by weight unless otherwise indicated.

The preferred PEI adhesion promoting materials promote bonding between the matrix and barrier resin layers while the materials are in contact with at least one material at an elevated melt temperature, such that it is difficult to separate the layers of a preform after the preform has cooled. The preferred adhesion promoting materials identified above are well suited for the chemistries of the disclosed barrier and matrix resins. The improved adhesion between the barrier and matrix layers, to reduce or prevent delamination of the wall layers during handling and use of the multilayer articles, is achieved while maintaining the clarity and transparency of the multilayer wall.

Containers and preforms in accordance with the present invention have a multilayer wall with at least one layer of matrix resin adjacent to at least one layer of barrier resin. (Additional layers not germane to the present invention may also be included). By way of example, a three-layer container or preform may have a wall with layers in the sequence matrix/barrier/matrix. A five-layer container or preform may have wall layers in the sequence matrix/barrier/matrix/barrier/matrix. The multiple layers may extend throughout the bottom wall and the sidewall of the container or preform, or may be confined to a portion of the sidewall or base, for example. Thus as used herein “multilayer article” means an article at least a portion of which has multiple layers.

There have thus been disclosed a multilayer article, adhesion promoting blend, and method of manufacture in conjunction with a number of exemplary embodiments. Other modifications and variations will readily suggest themselves to a person of ordinary skill in the art. The invention is intended to embrace all such modifications and variations as fall within the scope of the following claims.

1. A melt-formed multilayer article including:
at least one layer of matrix resin,
at least one layer of barrier resin and
a material blended with the barrier resin and/or the matrix resin to promote adhesion between the barrier and matrix layers, the adhesion promoting material including an amine polymer and an amount of a phosphorous material sufficient to thermally stabilize the adhesion promoting material in melt forming of the article.

2. The article of claim 1, wherein the phosphorous material is present in an amount sufficient to reduce or eliminate color changes of the adhesion promoting material during melt forming.

3. The article of claim 1, wherein the phosphorous material is present in an amount sufficient to reduce or eliminate yellowing of the adhesion promoting material during melt forming.

4. The article of claim 1, wherein the amine polymer is an imine polymer.

5. The article of claim 1, wherein the amine polymer is an alkylene amine polymer.

6. The article of claim 5, wherein the alkylene amine polymer is an alkylene imine polymer.

7. The article of claim 6, wherein the alkylene imine polymer is a polyethyleneimine polymer.

8. The article of claim 1, wherein the article is a preform having a multilayer wall for blow molding into a container.

9. The article of claim 1, wherein the article is a container having a multilayer wall.

10. The article of claim 1, wherein the phosphorous material comprises a phosphorous atom bound to one or more oxygen atoms.

11. The article of claim 10, wherein one or more of the oxygen atoms is bound to an organic substituent.

12. The article of claim 11, wherein the organic substituent includes an aromatic moiety.

13. The article of claim 10, wherein two or more aromatic moieties are bound to the phosphorous atom.

14. The article of claim 1, wherein the phosphorous material comprises one or more of a phosphite, a phosphonite and a phosphate.

15. The article of claim 1, wherein the phosphorous material comprises a phosphite.

16. The article of claim 15, wherein the phosphite includes one or more oxygen atoms bound to an organic substituent.

17. The article of claim 16, wherein the organic substituent includes an aromatic moiety.

18. The article of claim 1, wherein the matrix resin is ester-containing resin, polyolefin or polyamide.

19. The article of claim 18, wherein the matrix resin is polyester resin.

20. The article of claim 19, wherein the polyester resin is PET, PEN, a blend or copolymer of PET and PEN, or regrind that includes PET, PEN or blends or copolymers of PET and PEN.

21. The article of claim 1, wherein the barrier resin is EVOH, polyamide, acrylonitrile copolymers, a blend of EVOH and polyamide, a blend of polyester and polyamide, a nanocomposite of EVOH or polyamide and clay, a blend of EVOH and an ionomer, acrylonitrile, a cyclic olefin copolymer, polyglycolic acid, polyvinylidiene chloride, or a blend thereof.

22. The article of claim 21, wherein the barrier resin is EVOH or polyamide.

23. The article of claim 1, wherein the matrix resin is polyester and the barrier resin is EVOH.

24. The article of claim 1, wherein matrix resin is polyester and the barrier resin is polyamide.

25. The article of claim 1, wherein the matrix resin is polyethylene terephthalate (PET), polyethylene naphthalate (PEN), or a blend or copolymer of PET and PEN, and the barrier resin is EVOH or MXD6 polyamide.

26. The article of claim 1, wherein the article is a food or beverage preform or container.

27. The article of claim 1, wherein the article is a preform or container for organic liquids or solvents.

28. The article of claim 1, wherein the article is a package, container, preform, closure, liner, sheath or film.

29. The article of claim 1, wherein the adhesion promoting material in the article is substantially clear and transparent.

30. The article of claim 1, wherein the elemental phosphorous content of the adhesion promoting material is in a range of from about 0.1% to about 1.0% by weight of the amine polymer.

31. The article of claim 30, wherein the elemental phosphorous content is in a range of 0.5% to 1.0%.

32. A method of melt forming a multilayer plastic article including the steps of: (a) blending with a barrier resin an adhesion-promoting material comprising an amine polymer and an amount of a phosphorous material sufficient to thermally stabilize the adhesion promoting material in melt forming of the article, and (b) melt forming the article in which the blend formed in step (a) is in a layer adjacent to a layer of matrix resin and in which the amine polymer promotes adhesion between the barrier and matrix layers.

33. A barrier resin blend for use in a melt forming a multilayer plastic article, the barrier resin blend including: a barrier resin to resist transmission of one or more of gas, water vapor and flavorants, and a material that includes an amine polymer to promote adhesion between a layer of the barrier resin and an adjacent layer of a matrix resin in the melt formed article, the adhesion promoting material including an amount of a phosphorous material sufficient to thermally stabilize the adhesion promoting material in melt forming of the article.
